(19) United States
(12) Patent Application Publication
(10) Pub. No.: US 2011/0134450 A1
(43) Pub. Date: Jun. 9, 2011

(54) IMAGE DISPLAY APPARATUS THAT DISPLAYS INFORMATION ACCORDING TO SIZE OF PREVIEW IMAGE, CONTROL METHOD FOR IMAGE DISPLAY APPARATUS, AND STORAGE MEDIUM

(75) Inventor: Motoki Ikeda, Tokyo (JP)

(73) Assignee: CANON KABUSHIKI KAISHA, Tokyo (JP)

(21) Appl. No.: 12/957,867

(22) Filed: Dec. 1, 2010

(30) Foreign Application Priority Data
Dec. 9, 2009 (JP) 2009-279441

(51) Int. Cl. G06F 15/00; G09G 5/00

(52) U.S. Cl. 358/1.9; 345/660

(57) ABSTRACT

An image display apparatus that can appropriately display supplementary information according to a display magnification for a preview image. A size of a preview image indicative of a printing result of an image to be printed is determined according to an instruction from a user. A type of information on printing of the image, which is to be displayed on a display unit, is determined according to the determined size. Information of the determined type is displayed in a state in which the preview image is displayed on the display unit according to the determined size.

### BACKGROUND OF THE INVENTION

1. Field of the Invention

The present invention relates to an image display apparatus and a control method for the image display apparatus, and a computer-readable storage medium storing a program for causing a computer to implement the method.

2. Description of the Related Art

In image display apparatuses (image forming apparatuses) such as multifunctional peripherals, a preview image for an output image is displayed on a display unit such as a display. By seeing the preview image, a user can check the layout and tone of the output image, sharpness of characters, and so on. This can reduce misprints and the like.

For conventional image display apparatuses, there has been proposed a technique to express, in characters and icons, information such as the number of sheets and the residual amount of toner that cannot be expressed by a preview image (hereafter referred to as “supplementary information”), and display the information as well as the preview image on a display unit (Japanese Laid-Open Patent Publication (Kokai) No. 2001-113803). With this technique, a toner-out condition and a paper-out condition halfway through printing can be known in advance, which can reduce misprints and the like.

Also, there are image display apparatuses that can change display magnifications (enlargement ratio/reduction ratio) for a preview image. With such image display apparatuses, a user can check an output image in more detail by enlarging a preview image.

However, the size of the display unit on which a preview image is displayed by the image display apparatuses is limited. For this reason, when a user displays an enlarged preview image, supplementary information cannot be displayed.

Moreover, when a special-purpose region for displaying supplementary information is provided inside a display region of the display unit, a region where a preview image can be displayed is limited, and it is thus difficult for a user to check the preview image. Further, when the amount of supplementary information is large, all the supplementary information may not be displayed.

### SUMMARY OF THE INVENTION

The present invention provides an image display apparatus that can appropriately display supplementary information according to a display magnification for a preview image, a control method for the image display apparatus, and a computer-readable storage medium storing a program for causing a computer to implement the method.

Accordingly, a first aspect of the present invention provides an image display apparatus comprising a display unit configured to display a preview image indicative of a printing result of an image to be printed, and information on printing of the image, a size determination unit configured to determine a size of the preview image displayed by the display unit according to an instruction from a user, a type determination unit configured to determine a type of information to be displayed on a display part according to the size determined by the size determination unit, and a display control unit configured to display information of the type determined by the type determination unit in a state in which the preview image is displayed in the display part according to the size determined by the size determination unit.

Accordingly, a second aspect of the present invention provides a control method for an image display apparatus, comprising a display step of displaying a preview image indicative of a printing result of an image to be printed, and information on printing of the image, a size determination step of determining a size of the preview image displayed in the display step according to an instruction from a user, a type determination step of determining a type of information to be displayed on a display part according to the size determined in the size determination step, and a display control step of displaying information of the type determined in the type determination step in a state in which the preview image is displayed in the display part according to the size determined in the size determination step.

Accordingly, a third aspect of the present invention provides a computer-readable non-transitory storage medium storing a program for causing a computer to execute the control method for the image display apparatus as described above.

According to the present invention, supplementary information can appropriately be displayed according to a display magnification for a preview image.

Further features of the present invention will become apparent from the following description of exemplary embodiments (with reference to the attached drawings).

### BRIEF DESCRIPTION OF THE DRAWINGS

FIG. 1 is a block diagram schematically showing an arrangement of an image forming apparatus which is a first embodiment of an image display apparatus according to the present invention.

FIG. 2 is a data configuration diagram showing exemplary preview output definition data.

FIGS. 3A and 3B are views showing exemplary display data displayed as supplementary information on a display unit of a user interface.

FIGS. 4A to 4C are views showing exemplary display data displayed as supplementary information on the display unit of the user interface.

FIGS. 5A to 5D are views showing exemplary display data displayed as a preview image on the display unit of the user interface.

FIG. 6 is a flowchart useful in explaining a process in which a controller unit generates display data to be displayed on the display unit of the user interface.

FIG. 7 is a flowchart useful in explaining a process in which the controller unit generates voice data to be output to a speaker of the user interface.

FIG. 8 is a flowchart useful in explaining a process carried out by the controller unit when an enlargement ratio/reduction ratio is changed after a preview image is displayed.

FIGS. 9A and 9B are views showing exemplary screens displayed on the display unit of the user interface.

FIGS. 10A and 10B are views showing exemplary screens displayed on the display unit of the user interface.

FIGS. 11A and 11B are views showing exemplary screens displayed on the display unit of the user interface.

FIG. 12 is a data configuration diagram showing exemplary preview output definition data in an image forming apparatus which is a second embodiment of the image display apparatus according to the present invention.

FIG. 13 is a view showing exemplary display data displayed as a preview image on a display unit of a user interface.

FIGS. 14A and 14B are views showing exemplary screens displayed on the display unit of the user interface.

FIGS. 15A and 15B are views showing exemplary screens displayed on the display unit of the user interface.

FIGS. 16A and 16B are views showing exemplary screens displayed on the display unit of the user interface.

### DESCRIPTION OF THE EMBODIMENTS

The present invention will now be described in detail with reference to the drawings showing embodiments thereof.

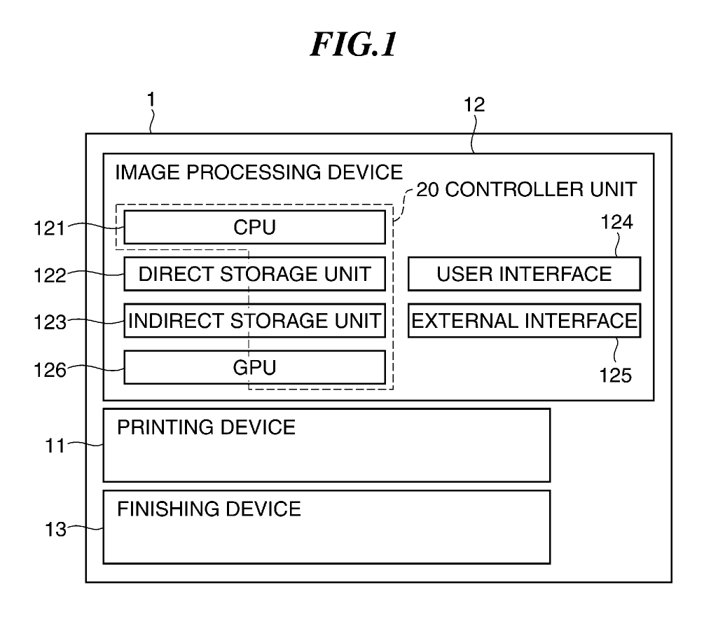

FIG. 1 is a block diagram schematically showing an arrangement of an image forming apparatus which is a first embodiment of an image display apparatus according to the present invention.

Referring to FIG. 1, the image forming apparatus 1 has a printing device 11, an image processing device 12, and a finishing device 13. The image processing device 12 is provided with a CPU 121, a direct storage unit 122, an indirect storage unit 123, a user interface 124, an external interface 125, and a GPU (graphics processing unit) 126.

The direct storage unit 122 is comprised of a RAM or the like, and directly exchanges data with the CPU 121. The direct storage unit 122 also temporarily stores information obtained when the CPU 121 executes a controller program, and the information includes a preview image. The indirect storage unit 123 is comprised of an HDD or the like, and exchanges data with the CPU 121 via the direct storage unit 122. The indirect storage unit 123 stores controller programs for controlling the image forming apparatus 1.

The user interface 124 has input units, display units, and so on such as a touch panel, a keyboard, and a mouse, and receives instructions from a user, and displays data according to the received instructions (display data) on the display unit. The user interface 124 also includes a speaker, and outputs voices from the speaker according to instructions from the CPU 121.

The external interface 125 is capable of sending and receiving data to and from external devices. Examples of the external devices include storage units such as an external HDD and an external USB memory, and other host computers and image forming apparatuses connected via a network.

The GPU 126 is a processer that performs a graphics process in place of the CPU 121, and is capable of enlarging, reducing, and modifying display data at high speed.

The printing device 11 prints an image generated by the image processing device 12 on a sheet and outputs the sheet. The finishing device 13 performs a finishing process such as stapling and folding on the sheet output by the printing device 11.

It should be noted that in the present embodiment, the image forming process, the printing process, and the finishing process performed by the printing device 11, the image processing device 12, and the finishing device 13 are referred to as “jobs”, and settings relating to the jobs are referred to as “job settings”.

The CPU 121 is capable of moving (storing) a controller program stored in the indirect storage unit 123 into the direct storage unit 122. When the movement is completed, the CPU 121 is ready to execute the controller program.

A controller unit 20 has the CPU 121, the GPU 126, and control program storage areas of the direct storage unit 122, and storage areas of the direct storage unit 122 and the indirect storage unit 123 for information obtained when the CPU 121 processes a control program. The controller unit 20 performs display control so as to display various screens on the user interface 124.

Next, a description will be given of how a preview image is generated.

Upon receiving a preview display instruction from the user, the user interface 124 notifies the controller unit 20 of this. The controller unit 20 generates a preview image from an image read by the image processing device 12 (an original image), or from an image received by the external user interface 125 (a received image) from an external apparatus. Images handled by the image forming apparatus 1 have considerably higher resolutions than resolutions of images displayed on a display unit of the user interface 124, and hence the preview image is generated at a lower resolution than resolutions of images handled by the image forming apparatus 1.

Then, the controller unit 20 generates display data from the generated preview image. Also, the controller unit 20 reduces or enlarges the generated preview image according to an enlargement ratio/reduction ratio in preview display to generate the display data.

The user interface 124 receives a change in display magnification for the preview image from the user. In the present embodiment, the display magnification can be designated within a range between 200[%] to 20[%].

The user interface 124 notifies the controller unit 20 of the received display magnification. According to the notified display magnification, the controller unit 20 generates display data from the preview image. When the display magnification is 200[%], the controller unit 20 generates the display data of the preview image in a size equal to the size of the original image or the received image. When the display magnification is less than 200[%], the controller unit 20 generates the display data by reducing the preview image according to that value. It should be noted that when the entire preview image cannot be displayed inside a display region of the display unit, the controller unit 20 enlarges and displays a part of the preview image on the user interface 124.

As described above, although in an actual process, display data is generated by reducing a preview image, the half size of a preview image is 100[%] conceptually in terms of display on the display unit of the user interface 124 and user instructions. In the following description, it is assumed that display magnifications more than 100[%] are enlargement ratios, and display magnifications less than 100[%] are reduction ratios.

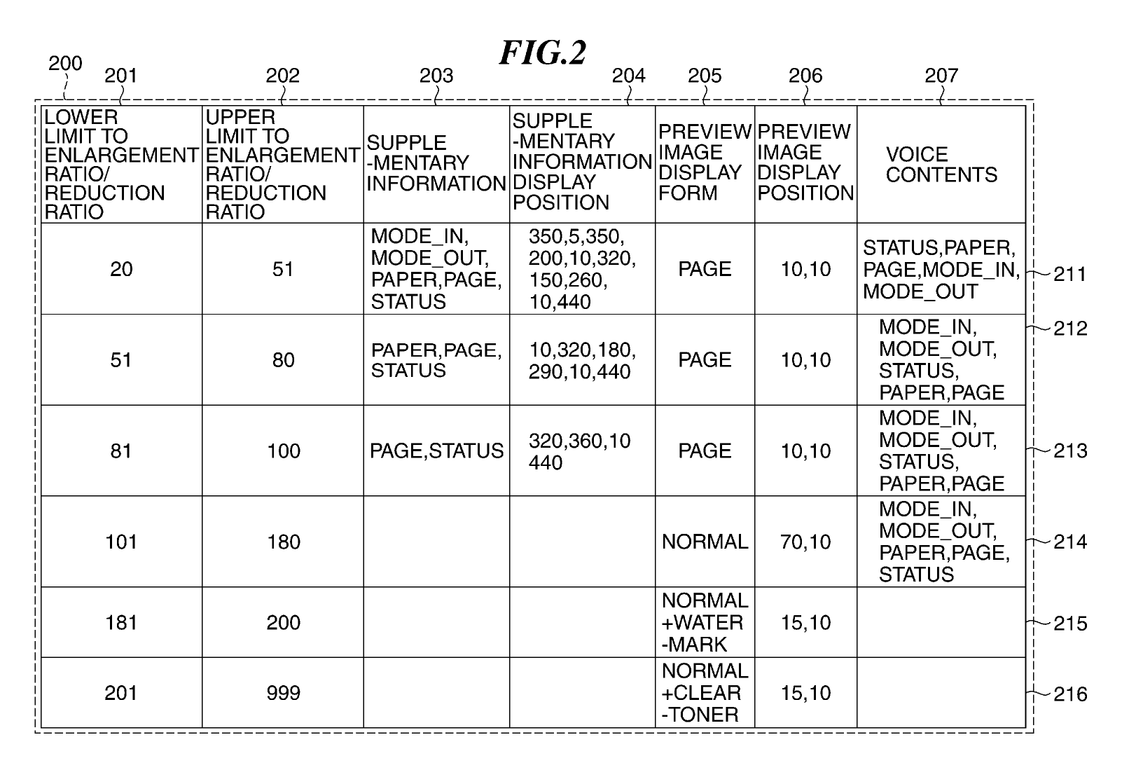

Referring next to FIG. 2, a description will be given of preview output definition data. FIG. 2 is a data constitution diagram showing exemplary preview output definition data.

The preview output definition data 200 is data that defines contents to be displayed on the display unit of the user interface 124, and voice contents to be output to the speaker according to an enlargement ratio/reduction ratio of a preview image, and is stored and managed by the controller unit 20.

One record (row) of the preview output definition data 200 corresponds to contents output to the display unit and the speaker of the user interface 124 according to the present enlargement ratio/reduction ratio.

A data item 201 and a data item 202 are data items indicative of an enlargement ratio/reduction ratio of a preview image. The user interface 124 produces a display on the display unit and outputs voice from the speaker according to contents of a record in which the present enlargement ratio/reduction ratio is not less than the value in the data item 201 and not more than the value in the data item 202.

A data item 203 is indicative of the type of supplemental information to be displayed. In the data item 203, any of the following character strings (information), or a plurality of the following character strings connected together by commas (,) are stored.

“PAGE” indicative of page information (the total number of pages, and page number). “PAPER” indicative of sheet information (sheet size, sheet type, and sheet feed cassette). “MODE_IN” indicative of information on reading of an original among job settings. “MODE_OUT” indicative of information other than information on reading of an original among job settings. “STATUS” indicative of apparatus status information.

It should be noted that in the following description, information on reading of an original is referred to as “job setting information (input)”, and information other than information on reading of an original among job settings is referred to as “job setting information (output)”.

A data item 204 is indicative of a position at which supplementary information indicated by the data item 203 is to be displayed. The position is on the display unit of the user interface 124, and a horizontal position (x) and a vertical position (y) are stored in the form of {x, y}. When a plurality of types of supplementary information to be displayed are stored in the data item 203, values of respective display positions therefor connected together by commas (,) are stored. Namely, the display positions are stored in the form of {x1, y1, x2, y2, . . . , x{n}, y{n}} ({n} is the number of supplementary information pieces to be displayed).

It should be noted that in the present embodiment, it is assumed that the display unit of the user interface 124 is comprised of a VGA display.

A data item 205 is indicative of a display form of a preview image. The following information is stored in the data item 205: “NORMAL” indicative of a form in which a normal sheet is displayed, “PAGE” indicative of a form in which a normal sheet and part of fore-and-aft pages are displayed, “NORMAL+WATERMARK” indicative of a form in which a normal sheet and an appearance of watermark prints on a preview image are displayed, “PAGE+WATERMARK” indicative of a form in which a normal sheet and an appearance of watermark prints on a preview image are displayed while part of fore-and-aft pages is also displayed, “NORMAL+CLEARTONER” indicative of a form in which a normal sheet and an appearance of clear toner on a preview image are displayed, and “PAGE+CLEARTONER” indicative of a form in which a normal sheet and an appearance of clear toner on a preview image are displayed while part of fore-and-aft pages is also displayed.

A data item 206 is indicative of a position at which a preview image is to be displayed.

A data item 207 is indicative of contents of voices output via the speaker of the user interface 124. Information stored in the data item 207 is of the same type as the information stored in the data item 203. Moreover, similarly to the data item 203, a plurality of character strings connected together by commas (,) can be stored.

As a concrete example of the data items 201 to 206, a record 212 of the preview output definition data 200 will now be described. Data items in the record 212 will be described below.

When the enlargement ratio/reduction ratio is not less than “51”% (the data item 201) and not more than “80”% (the data item 202), contents explained hereafter are output.

Sheet information (“PAPER”), page information (“PAGE”), and apparatus status information (“STATUS”) are displayed as supplementary information data (the data item 203).

The sheet information is displayed at a position (x, y)=(10, 320) on the user interface 124. The page information is displayed at a position (x, y)=(180, 290) on the user interface 124. The apparatus status information is displayed at a position (x, y)=(10, 440) on the user interface 124 (the data item 204). It should be noted that the position (x, y) indicates an upper left end of information to be displayed (drawing starting position). However, this way of expression in coordinates is only one example, and coordinates may be expressed in any other method. For example, values indicative of a center position of information to be displayed may be adopted.

A preview image is displayed on a plain sheet accompanied by fore-and-aft pages (“PAGE”), and at a position (x, y)=(10, 10) on the user interface 124 (the data item 205 and the data item 206).

Contents of job setting information (input) (“MODE_IN”), job setting information (output) (“MODE_OUT”), apparatus status information (“STATUS”), sheet information (“PAPER”), and page information (“PAGE”) are output in this order to the speaker (the data item 207)

Next, a description will be given of supplementary information displayed on the display unit of the user interface 124.

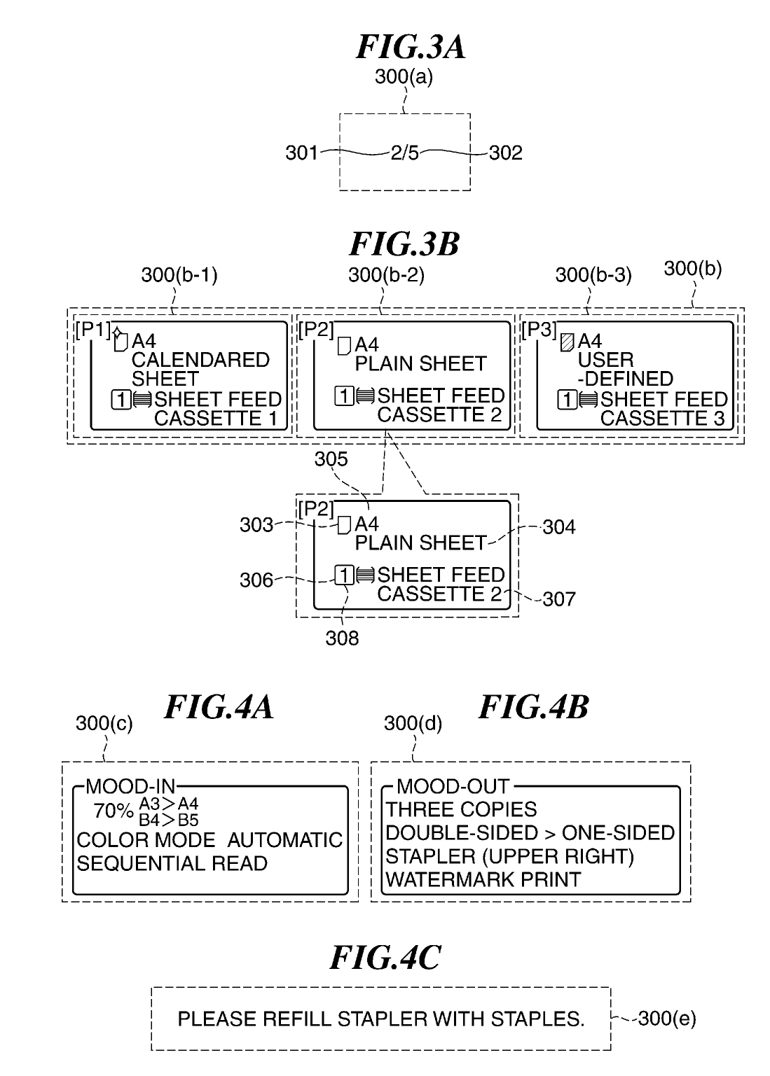

FIGS. 3A to 4C are views showing exemplary display data displayed as supplementary information displayed on the display unit of the user interface 124.

According to a value stored in the data item 203, the controller unit 20 determines contents of supplementary information, and generates display data to be displayed as the supplementary information displayed on the display unit of the user interface 124.

When “PAGE” is stored in the data item 203, the controller unit 20 generates display data 300(a) shown in FIG. 3A. A display part 301 of the display data 300(a) indicates a page number of a preview image being currently displayed, and a display part 302 of the display data 300(a) indicates the total number of pages.

When “PAPER” is stored in the data item 203, the controller unit 20 generates display data 300(b) shown in FIG. 3B, and displays sheet information output by the printing device 11. Sheet information on a page being currently displayed is displayed in a display region 300(b-2) of the display data 300(b), sheet information on the previous page is displayed in a display region 300(b-1) of the display data 300(b), and sheet information on the next page is displayed in a display region 300(b-3) of the display data 300(b). It should be noted that when there is no page before and after a page being currently displayed as in a case where the total number of pages is one, the display regions 300(b-1) and 300(b-3) are hidden.

Contents displayed in the display regions 300(b-1), 300(b-2), and 300(b-3) are similar as described below.

A display part 303 and a display part 304 are an icon and a character string, respectively, which indicate a type of a sheet. A display part 305 indicates a size of the sheet. A display part 306 and a display part 307 are an icon and a character string, respectively, which indicate a sheet feed cassette from which the sheet is to be fed. A display part 308 indicates the amount of sheets remaining in the sheet feed cassette indicated by the display part 306 and the display part 307.

When “MODE_IN” is stored in the data item 203, the controller unit 20 generates display data 300(c) shown in FIG. 4A. The display data 300(c) represents job setting information (input) such as magnification, color mode, and whether or not sequential reading is to be performed.

When “MODE_OUT” is stored in the data item 203, the controller unit 20 generates display data 300(d) shown in FIG. 4B. The display data 300(d) represents job setting information (input) such as the number of copies, finishing, and the presence or absence of a watermark.

When “STATUS” is stored in the data item 203, the controller unit 20 generates display data 300(e) in shown in FIG. 4C. The display data 300(e) represents status information on the apparatus.

Next, a description will be given of a display form of a preview image.

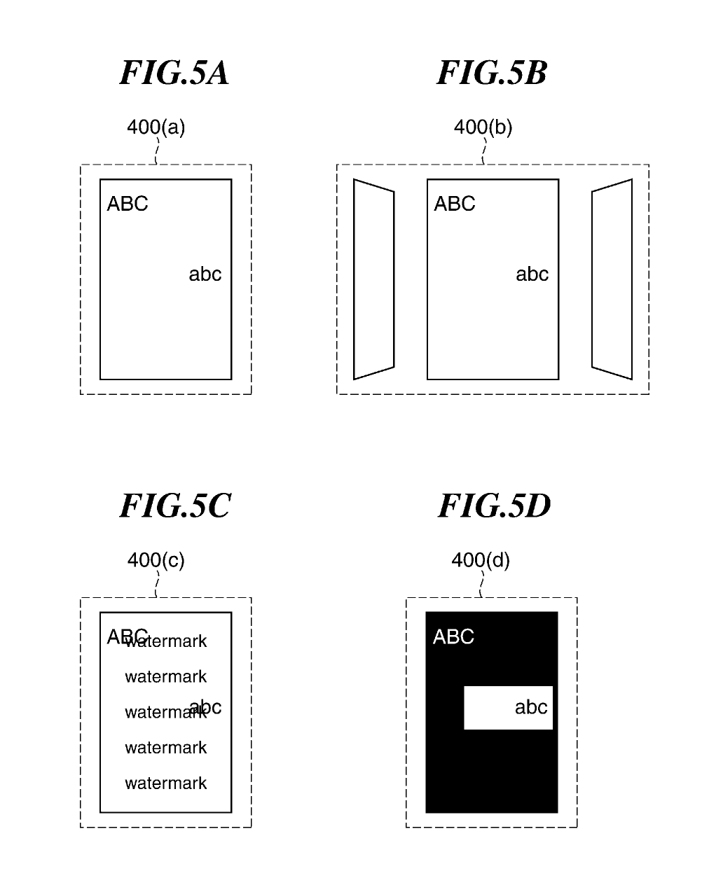

FIGS. 5A to 5D are views showing exemplary display data displayed as a preview image on the display unit of the user interface 124.

According to a value stored in the data item 205, the controller unit 20 determines a display form of a preview image, and generates display data to be displayed on the display unit of the user interface 124.

When “NORMAL” is stored in the data item 205, the controller unit 20 generates display data 400(a) of the preview image in a form shown in FIG. 5A. The display data 400(a) of the preview image is generated in a rectangular part on the present page.

When “PAGE” is stored in the data item 205, the controller unit 20 generates display data 400(b) of the preview image in a form shown in FIG. 5B. As the display data 400(b), display data of the preview image on the present page is generated in a central rectangular part, display data of a preview image on the previous page is generated in a left rectangular part, and display data of a preview image on the next page is generated in a right rectangular part. It should be noted that there is no page before or after the present page, display data of a preview image is not generated in the left rectangular part or the right rectangular part.

When “NORMAL+WATERMARK” is stored in the data item 205, the controller unit 20 generates display data 400(c) comprised of the preview image in the same form as in the case of “NORMAL” with watermark images added thereto as shown in FIG. 5C.

When “NORMAL+CLEARTONER” is stored in the data item 205, the controller unit 20 generates display data 400(d) in a form shown in FIG. 5D. As the display data 400(d), display data of the preview image in the same form as in the case of “NORMAL” and an area of a clear toner print is displayed in black.

When “PAGE+WATERMARK” is stored in the data item 205, the controller unit 20 generates display data 400(b) of the preview image in the same form as in the case of “PAGE”. Additionally, the controller unit 20 generates the same watermarks as in the case of “NORMAL+WATERMARK” in the display data 400(b) of the preview image.

When “PAGE+CLEARTONER” is stored in the data item 205, the controller unit 20 generates display data 400(b) of the preview image in the same form as in the case of “PAGE”. Additionally, the controller unit 20 displays in black an area other than an area in which clear toner is put as in the case of “NORMAL+CLEARTONER” in the display data 400(b) of the preview image.

Next, a description will be given of voice data output via the speaker of the user interface 124.

According to a value stored in the data item 207, the controller unit 20 determines voice contents, and generates voice data to be output via the speaker of the user interface 124.

When “PAGE” is stored in the data item 207, the controller unit 20 generates voice data, for example, “Total number of pages, five. Present page number, two.” concerning page information.

When “PAPER” is stored in the data item 207, the controller unit 20 generates voice data, for example, “Sheet size A4, calendared sheet. Sheet feed cassette one.” concerning sheet information. Moreover, when in the concerned sheet feed cassette, there are only a small number of sheets, or there are no sheets, the controller unit 20 generates voice data, for example, “Running short of sheets” and “Sheets have run out” after the above voice data.

When “MODE_IN” is stored in the data item 207, the controller unit 20 generates voice data, for example, “Magnification, regular-size, 70%. Color mode, black-and-white. Sequential reading, yes” concerning job setting information (input).

When “MODE_OUT” is stored in the data item 207, the controller unit 20 generates voice data, for example, “Number of copies, three. Double-sided setting, from double-sided to one-sided. Finishing, stapling, upper left. Watermark printing, yes” concerning job setting information (output).

When “STATUS” is stored in the data item 207, the controller unit 20 generates voice data, for example, “Please refill stapler with staples” concerning apparatus status information.

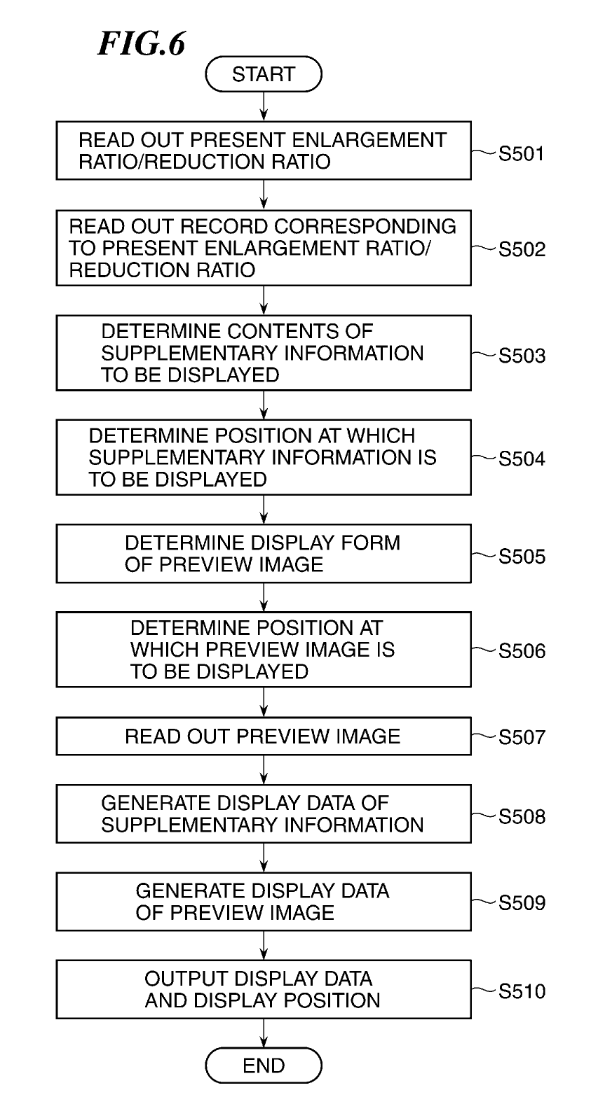

Next, a description will be given of a preview display data generation process. FIG. 6 is a flowchart useful in explaining a process in which the controller unit 20 generates display data to be displayed on the display unit of the user interface 124.

In step S501, the controller unit 20 reads out the present enlargement ratio/reduction ratio stored in a predetermined storage area, and proceeds to step S502.

In the step S502, the controller unit 20 obtains a record corresponding to the present enlargement ratio/reduction ratio from the preview output definition data 200 stored in a predetermined storage area, and proceeds to step S503.

Here, the controller unit 20 obtains such a record that the present enlargement ratio/reduction ratio is not less than a value in the data item 201 and not more than a value in the data item 202. It should be noted that the record obtained here is used in a voice data generation process, described later, and hence the controller unit 20 stores data on the obtained record in a predetermined storage area.

In the step S503, the controller unit 20 analyzes the value in the data item 203 of the record obtained in the step S502, determines contents to be displayed as supplementary information on the display unit of the user interface 124, and proceeds to step S504.

Here, the controller unit 20 separates the value in the data item 203 by commas (,) to obtain character strings indicative of supplementary information. For example, in the case of the record 212, “PAPER, PAGE, STATUS” is stored in the data item 203. Thus, in this case, the obtained supplementary information is sheet information (“PAPER”), page information (“PAGE”), and apparatus information (“STATUS”). The process carried out here corresponds to an exemplary first determination unit of the present invention.

In the step S504, the controller unit 20 analyzes the value in the data item 204 obtained in the step S502, determines a position at which the supplementary information is displayed as supplementary information on the display unit of the user interface 124, and proceeds to step S505.

Here, the controller unit 20 separates the value in the data item 204 by commas (,) to obtain coordinate values indicative of display positions. For example, in the case of the record 212, coordinate values (x, y)=(10, 320) indicative of a position at which the sheet information is displayed are obtained, coordinate values (x, y)=(180, 290) indicative of a position at which the page information is displayed are obtained, and coordinate values (x, y)=(10, 440) indicative of a position at which the apparatus status information is displayed are obtained.

In the step S505, the controller unit 20 determines a preview image display form based on the value in the data item 205 obtained in the step S502, and proceeds to step S506. Here, in the case of the record 212, for example, the controller unit 20 determines a preview image display form shown in FIG. 5B. The process carried out here corresponds to an exemplary second determination unit of the present invention.

In the step S506, the controller unit 20 obtains a preview image display position based on the value in the data item 206 obtained in the step S502, and proceeds to step S507. Here, in the case of the record 212, for example, the controller unit 20 obtains coordinate values (x, y)=(10, 1) indicative of a preview image display position.

In the step S507, the controller unit 20 reads out a preview image stored in a predetermined storage area, and proceeds to step S508.

In the step S508, the controller unit 20 generates display data based on the contents of the supplementary information determined in the step S503, and proceeds to step S509. On this occasion, the controller unit 20 generates display data according to job settings of a job corresponding to an image to be previewed. For example, assume that a job is comprised of a plurality of pages, and for this job, it is specified that a first page is printed on a calendared sheet, a second page is printed on a plain sheet, and a third page is printed on a user-defined sheet. When receiving the job, the controller unit 20 manages those job settings in the indirect storage unit 123, and generates and displays a preview image according to those job settings and the supplementary information determined in the step S503.

In the step S509, the controller unit 20 generates display data based on the preview image display form obtained in the step S505 and the preview image read out in the step S507, and proceeds to step S510.

In the step S510, the controller unit 20 outputs the display data generated in the steps S508 and S509, and the positions obtained in the steps S504 and S506 to the display unit of the user interface 124, and terminates the process.

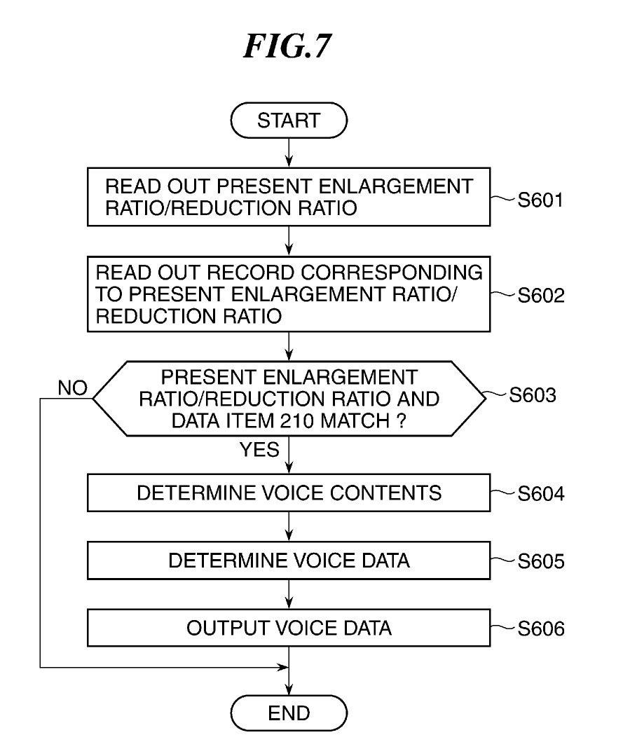

FIG. 7 is a flowchart useful in explaining a process in which the controller unit 20 generates voice data to be output to the speaker of the user interface 124.

In step S601, the controller unit 20 reads out the present enlargement ratio/reduction ratio stored in a predetermined storage area, and proceeds to step S602.

In the step S602, the controller unit 20 reads out a record corresponding to the present enlargement ratio/reduction ratio in the preview output definition data 200 stored in the step S502 in FIG. 6, and proceeds to step S603.

In the step S603, the controller unit 20 determines whether or not a value in the data item 201 of the record read out in the step S602 matches the present enlargement ratio/reduction ratio read out in the step S601.

Then, when the value in the data item 201 read out in the step S602 matches the present enlargement ratio/reduction ratio read out in the step S601, the controller unit 20 proceeds to step S604, and when not, the controller unit 20 terminates the process.

In the step S604, the controller unit 20 analyzes a value in the data item 207 of the record read out in the step S602, determines voice contents to be output via the speaker of the user interface 124, and proceeds to step S605.

Here, the controller unit 20 separates the value in the data item 207 by commas (,) to obtain character strings indicative of voice contents. For example, in the case of the record 212, “MODE_IN, MODE_OUT, STATUS, PAPER, PAGE” is stored in the data item 207. Thus, voice contents that job setting information (input), job setting information (output), apparatus status information, sheet information, and page information are output in this order from the speaker are obtained. Thus, the voice contents indicative of supplementary information that cannot be displayed on the display unit at the present enlargement ratio/reduction ratio are preferentially output via the speaker. The process carried out here corresponds to an exemplary third determination unit of the present invention.

In the step S605, the controller unit 20 generates voice data based on the voice contents obtained in the step S604, and proceeds to step S606.

In the step S606, the controller unit 20 outputs the voice data generated in the step S605 to the speaker of the user interface 124, and terminates the process.

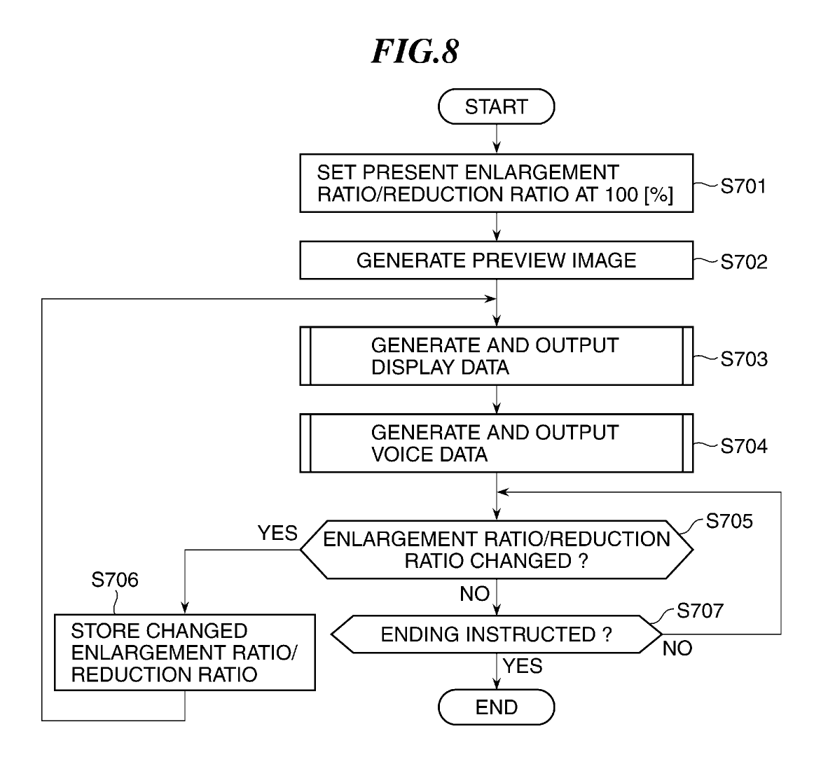

FIG. 8 is a flowchart useful in explaining a process carried out by the controller unit 20 when an enlargement ratio/reduction ratio is changed after a preview image is displayed.

In step S701, the controller unit 20 sets the present enlargement ratio/reduction ratio at 100[%], stores the same in a predetermined storage area, and proceeds to step S702.

In the step S702, the controller unit 20 generates a preview image from an image read by the image processing device 12, or an image received from an external apparatus by the external interface 125, and proceeds to step S703.

In the step S703, the controller unit 20 generates display data of the preview image and supplementary information by performing the process described above with reference to FIG. 6, outputs the same to the display unit of the user interface 124, and proceeds to step S704. As a result, the preview image and the supplementary information are displayed on the display unit of the user interface 124.

In the step S704, the controller unit 20 generates voice data by performing the process described above with reference to FIG. 7, outputs the same to the speaker of the user interface 124, and proceeds to step S705. As a result, voice is output from the speaker of the user interface 124.

In the step S705, the controller unit 20 determines whether or not the present enlargement ratio/reduction ratio has been changed by a user's operation on the user interface 124. When the present enlargement ratio/reduction ratio has been changed, the controller unit 20 proceeds to step S706, and when the present enlargement ratio/reduction ratio has not been changed, the controller unit 20 proceeds to step S707.

In the step S706, the controller unit 20 stores the enlargement ratio/reduction ratio changed in the step S705 in a predetermined storage area, returns to the step S703, and performs the process in the step S703 and the subsequent processes at the changed enlargement ratio/reduction ratio.

In the step S707, the controller unit 20 determines whether or not the user has issued an instruction to end the preview display. When the user has issued the instruction to end the preview display, the controller unit 20 terminates the process, and when the user has not issued the instruction to end the preview display, the controller unit 20 returns to the step S705.

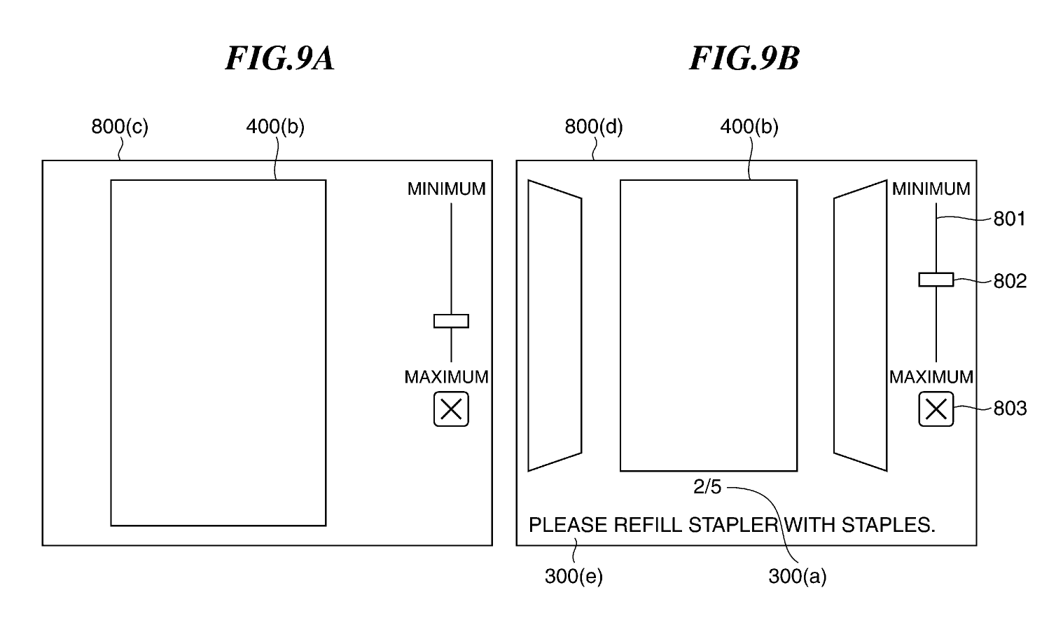

Referring next to FIGS. 9A to 11B, a description will be given of exemplary screens displayed on the display unit of the user interface 124.

When the user issues an instruction to produce a preview display through operation on the input unit of the user interface 124, the controller unit 20 displays a screen 800(d) shown in FIG. 9B. The screen 800(d) displays contents corresponding to the record 213 of the preview output definition data 200. Specifically, a preview image is displayed in the form of the display data 400(b) shown in FIG. 5B. Supplementary information is displayed such that page information with the contents of the display data 300(a) shown in FIG. 3A is displayed, and apparatus status information with the contents of the display data 300(e) shown in FIG. 4C is displayed. In the preview display designated by the reference numeral 800(d), a second page among five pages is displayed in the middle. It should be noted that in preview displays shown in FIGS. 9A to 11B, for each sheet to be displayed, an image to be actually printed on the sheet is overlaid on the sheet. As a result, a printing result is displayed as a preview display on the display unit.

A slider 801 is for designating an enlargement ratio/reduction ratio for a preview display. By moving a control 802 upward on the screen, the display size of the preview image is reduced, and by moving a control 802 downward on the screen, the display size of the preview image is enlarged. Here, moving the control 802 upward on the screen is referred to as “the reducing instruction”, and moving the control 802 downward on the screen is referred to as “the enlarging instruction”. A close button 803 is for issuing an instruction to end the preview display. When the close button 803 is operated, the controller unit 20 ends the preview display, and makes a transition to a previous screen (not shown).

It should be noted that the slider 801, the control 802, and the close button 803 are the same as those in screens 800(a), 800(b), 800(c), 800(d), 800(e), and 800(f), and therefore, description thereof is omitted below. The controller unit 20 displays these screens according to the preview output definition data shown in FIG. 2.

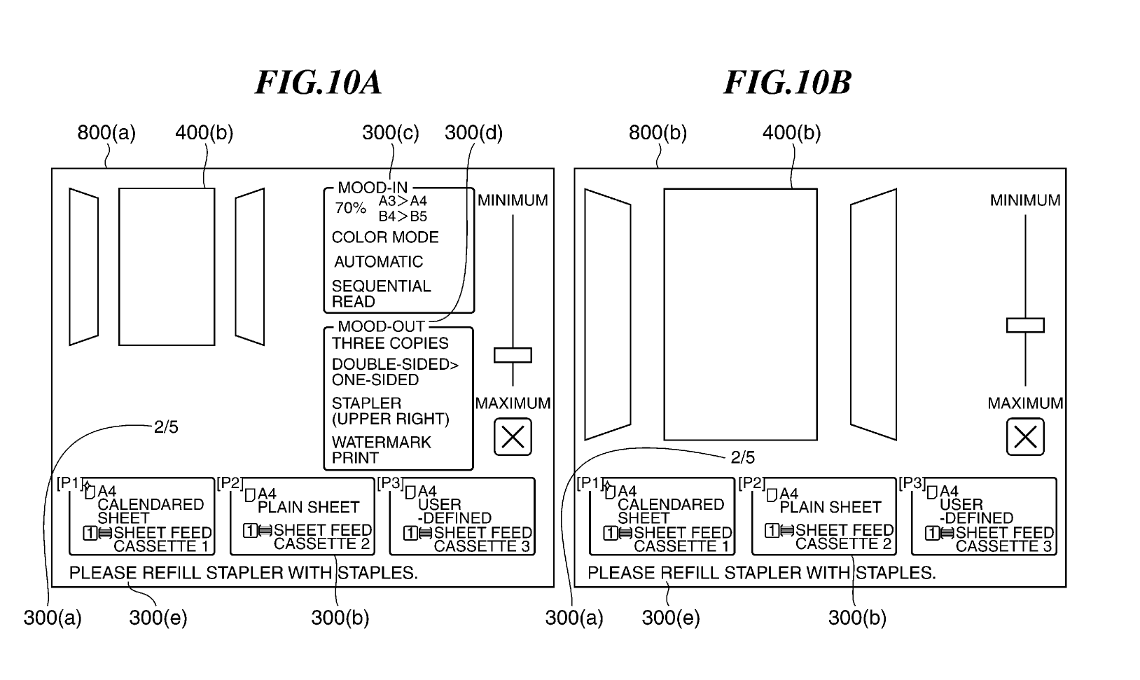

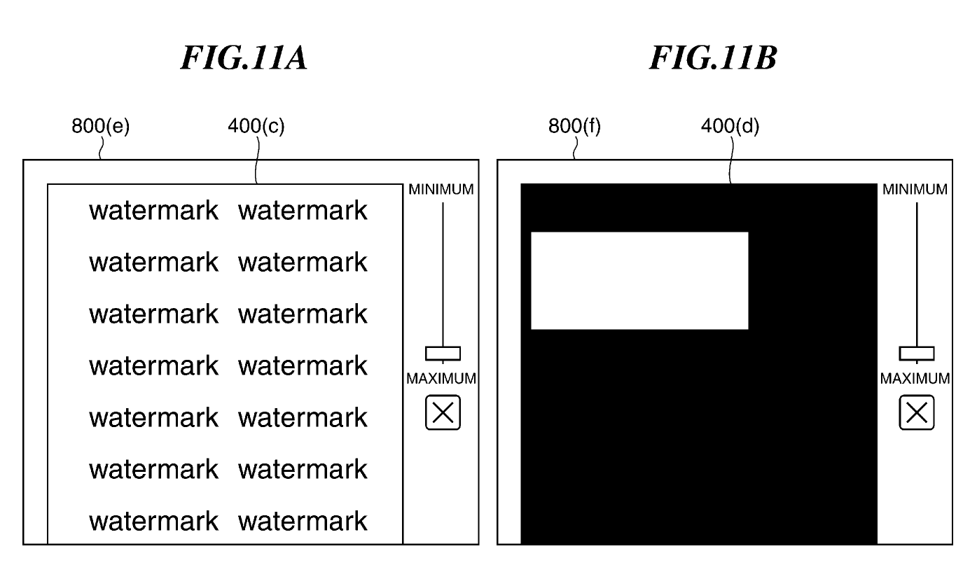

When the reducing instruction is issued in the state in which the screen 800(d) is displayed, the controller unit 20 displays the screen 800(b) shown in FIG. 10B on the display unit of the user interface 124. The screen 800(b) displays contents corresponding to the record 212 of the preview output definition data 200. Specifically, a preview image is displayed in the form of the display data 400(b) similarly to the screen 800(d). Supplementary information is displayed such that sheet information with the contents in the display data 300(b) shown in FIG. 3B is displayed in addition to the contents displayed on the screen 800(d). It should be noted that when the enlarging instruction is issued in the state in which the screen 800(b) is displayed, the controller unit 20 displays the screen 800(d) shown in FIG. 9B on the display unit of the user interface 124.

When the reducing instruction is issued in the state in which the screen 800(b) is displayed, the controller unit 20 displays the screen 800(a) shown in FIG. 10A on the display unit of the user interface 124. The screen 800(a) displays contents corresponding to the record 211 of the preview output definition data 200. Specifically, a preview image is displayed in the form of the display data 400(b) similarly to the screen 800(b). Supplementary information is displayed such that the contents in the display data 300(c) shown in FIG. 4A for job setting information (input) and the display data 300(d) shown in FIG. 4B for job setting information (output) are displayed in addition to the contents displayed on the screen 800(b). It should be noted that when the enlarging instruction is issued in the state in which the screen 800(a) is displayed, the controller unit 20 displays the screen 800(b) on the display unit of the user interface 124.

When the enlarging instruction is issued in the state in which the screen 800(d) is displayed, the controller unit 20 displays the screen 800(c) shown in FIG. 9A on the display unit of the user interface 124. The screen 800(c) displays contents corresponding to the record 214 of the preview output definition data 200. Specifically, a preview image is displayed in the form of the display data 400(b) shown in FIG. 5A (present page). It should be noted that on the screen 800(c), supplementary information is not displayed. Moreover, when the reducing instruction is issued in the state in which the screen 800(c) is displayed, the controller unit 20 displays the screen 800(d) shown in FIG. 9B on the display unit of the user interface 124.

When the enlarging instruction is issued in the state in which the screen 800(c) is displayed, the controller unit 20 displays the screen 800(e) shown in FIG. 11A on the display unit of the user interface 124. The screen 800(e) displays contents corresponding to the record 215 of the preview output definition data 200. Specifically, a preview image is displayed in the form of the display data 400(c) shown in FIG. 5C (an appearance of watermarks is displayed). It should be noted that when the reducing instruction is issued in the state in which the screen 800(e) is displayed, the controller unit 20 displays the screen 800(c) shown in FIG. 9A on the display unit of the user interface 124.

When the enlarging instruction is issued (a magnification not less than the maximum magnification is designated) in the state in which the screen 800(e) is displayed, the controller unit 20 displays the screen 800(f) shown in FIG. 11B on the display unit of the user interface 124. The screen 800(f) displays contents corresponding to the record 216 of the preview output definition data 200. Specifically, a preview image is displayed in the form of the display data 400(d) shown in FIG. 5D (an appearance of clear toner is displayed). It should be noted that when the reducing instruction is issued in the state in which the screen 800(f) is displayed, the controller unit 20 displays the screen 800(e) shown in FIG. 11A on the display unit of the user interface 124.

As described above, in the present embodiment, the display form of supplementary information other than a preview image and the display form of the preview image itself are controlled according to an enlargement ratio/reduction ratio in a preview display so that the type of information to be displayed with the preview image and the display form of the preview image can be changed. As a result, information appropriate to contents which the user would like to check by enlarging/reducing the preview image can be displayed on the display unit, and hence user convenience can be enhanced.

Moreover, when the present enlargement ratio/reduction ratio in a preview display is a predetermined value, supplementary information is output from the speaker by voice at the same time when a preview image is displayed. The voice is output such that information which is not displayed on the display unit at the present enlargement ratio/reduction ratio is preferentially output. For this reason, the user can know supplementary information which is not displayed on the display unit, and hence user convenience can be further enhanced.

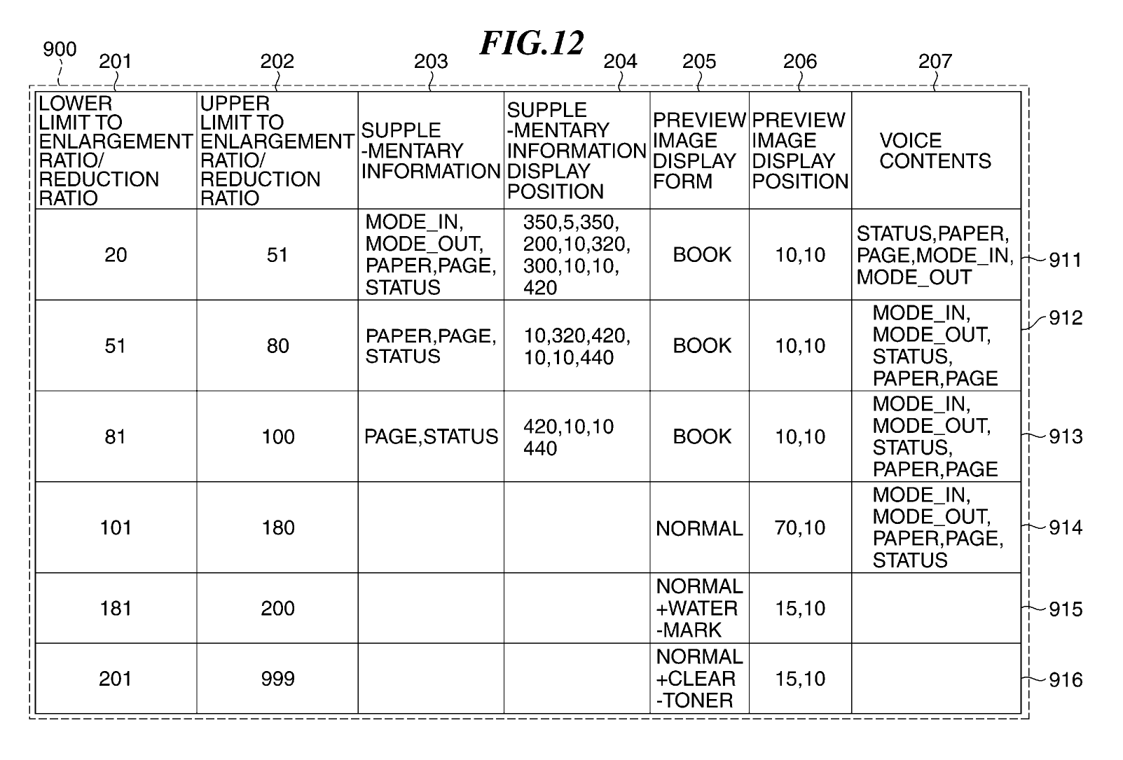

Referring next to FIGS. 12 to 16B, a description will be given of an image forming apparatus which is a second embodiment of the image display apparatus according to the present invention. It should be noted that elements and parts overlapping or equivalent to those in the above described first embodiment will be described using the same figures and reference numerals.

In the description of the present embodiment, it is assumed that “bookbinding” is set as a job setting. In the above described first embodiment, any of the following information pieces can be stored in the data item 205 of the preview output definition data 200 (the display form of the preview image): “NORMAL”, “PAGE”, “NORMAL+WATERMARK”, “NORMAL+CLEARTONER”, “PAGE+WATERMARK”, and “PAGE+CLEARTONER”.

In the present embodiment, “BOOK” indicative of a bookbinding output form as well as the above information can be stored in the data item 205.

FIG. 12 is a data configuration diagram showing exemplary preview output definition data 900 used in the present embodiment. The preview output definition data 900 is data that defines contents to be output to the display unit and the speaker of the user interface 124 according to an enlargement ratio/reduction ratio of a preview image, and is stored and managed by the controller unit 20.

Data items and records of the preview output definition data 900 are the same as those of the preview output definition data 200 used in the above described first embodiment except for contents described hereafter.

A value in the data item 205 of a record 911 represents “BOOK”, and a display part of page information in the data item 204 is (x, y)=(300, 10). A value in the data item 205 of a record 912 represents “BOOK”, and a display position of page information in the data item 204 is (x, y)=(420, 10). A value in the data item 205 of a record 913 represents “BOOK”, and a display position of page information in the data item 204 is (x, y)=(420, 10).

Next, a description will be given of a display form of a preview image.

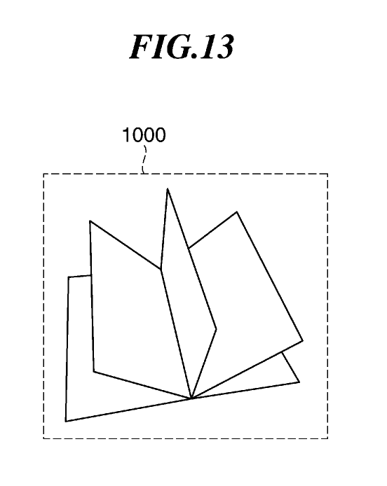

FIG. 13 is a view showing exemplary display data displayed as a preview image on the display unit of the user interface 124.

According to a value stored in the data item 205, the controller unit 20 determines a display form of a preview image, and generates display data to be displayed on the display unit of the user interface 124.

When the following information is stored in the data item 205, the same processes as those described above with reference to FIGS. 5A to 5D are performed: “NORMAL”, “PAGE”, “NORMAL+WATERMARK”, “NORMAL+CLEARTONER”, “PAGE+WATERMARK”, and “PAGE+CLEARTONER”.

Also, when “BOOK” is stored in the data item 205, the controller unit 20 generates display data 1000 for a preview image in a form shown in FIG. 13 (i.e. a form of a bound output).

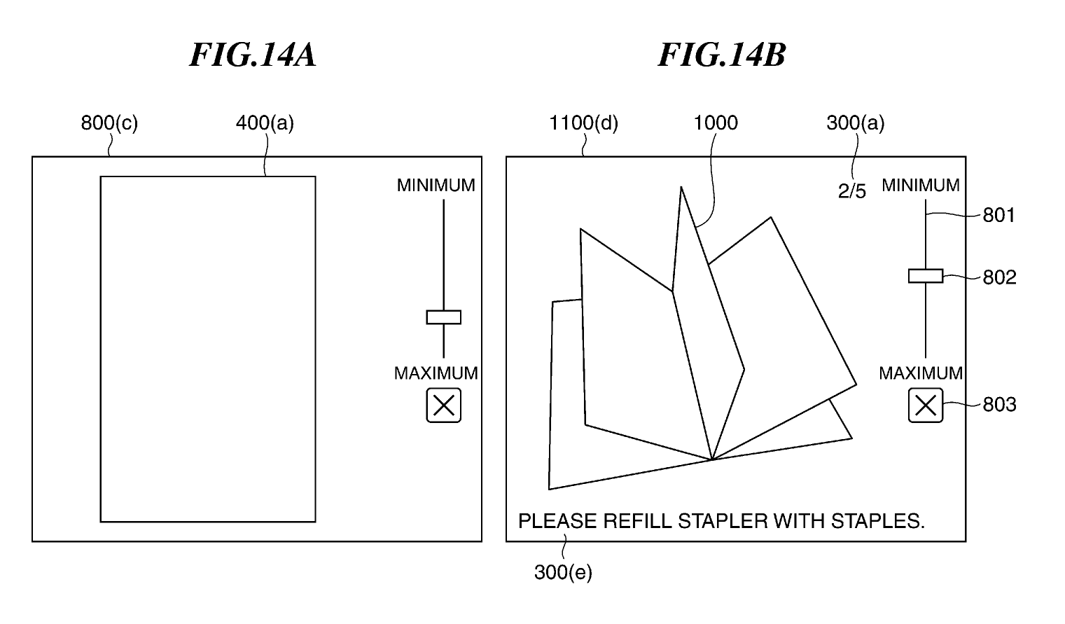

Referring next to FIGS. 14A to 16B, a description will be given of exemplary screens displayed on the display unit of the user interface 124.

When the user issues an instruction to produce a preview display through operation on the input unit of the user interface 124, the controller unit 20 displays a screen 1100(d) shown in FIG. 14B. The screen 1100(d) displays contents corresponding to the record 913 of the preview output definition data 900. Specifically, a preview image is displayed in the form of the display data 1000 shown in FIG. 13, and as supplementary information, the same contents as those on the screen 800(d) shown in FIG. 9B are displayed. It should be noted that in preview displays shown in FIGS. 13A to 16B, for each sheet to be displayed, an image to be actually printed on the sheet is overlaid on the sheet.

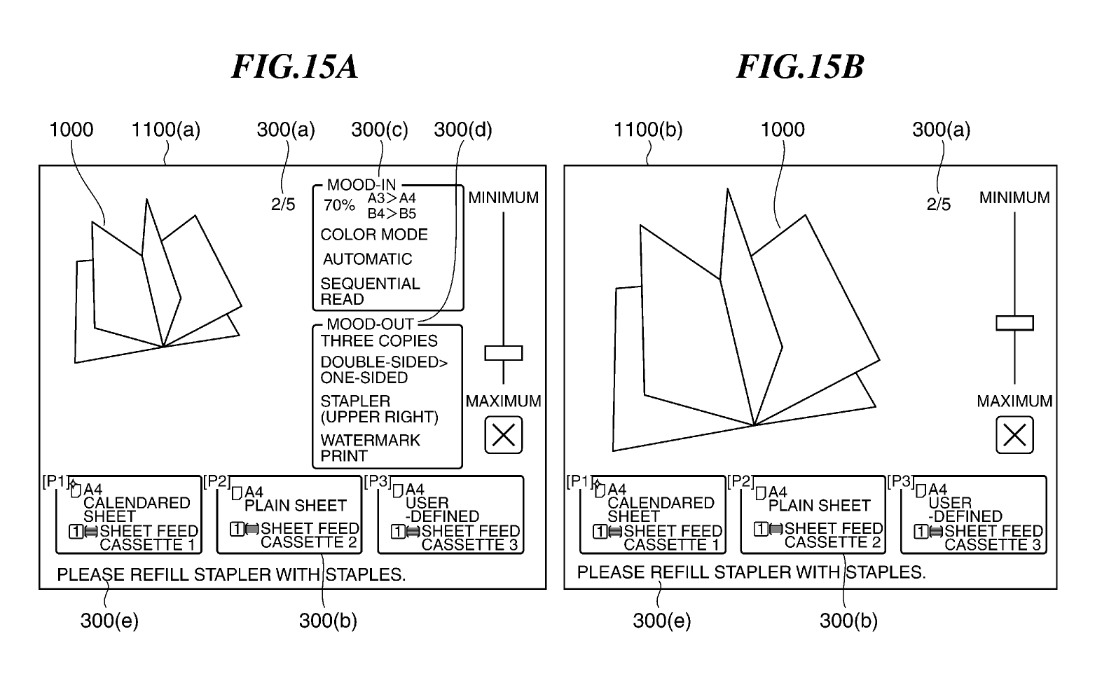

When the reducing instruction is issued in the state in which the screen 1100(d) is displayed, the controller unit 20 displays a screen 1100(b) shown in FIG. 15B on the display unit of the user interface 124. The screen 1100(b) displays contents corresponding to the record 912 of the preview output definition data 900. Specifically, a preview image is displayed in the form of the display data 1000 similarly to the screen 1100(d), and as supplementary information, the same contents as those on the screen 800(b) shown in FIG. 10B are displayed. It should be noted that when the enlarging instruction is issued in the state in which the screen 1100(b) is displayed, the controller unit 20 displays the screen 1100(d) on the display unit of the user interface 124.

When the reducing instruction is issued in the state in which the screen 1100(b) is displayed, the controller unit 20 displays a screen 1100(a) shown in FIG. 15A on the display unit of the user interface 124. The screen 1100(a) displays contents corresponding to the record 911 of the preview output definition data 900. Specifically, a preview image is displayed in the form of the display data 1000 similarly to the screen 1100(b), and as supplementary information, the same contents as those on the screen 800(a) shown in FIG. 10A are displayed. It should be noted that when the enlarging instruction is issued in the state in which the screen 1100(a) is displayed, the controller unit 20 displays the screen 1100(b) on the display unit of the user interface 124.

When the enlarging instruction is issued in the state in which the screen 1100(d) is displayed, the controller unit 20 displays a screen 800(c) shown in FIG. 14A on the display unit of the user interface 124. The screen 800(c) displays contents corresponding to the record 914 of the preview output definition data 900, and the displayed contents are the same as those shown in FIG. 9A. It should be noted that when the reducing instruction is issued in the state in which the screen 800(c) is displayed, the controller unit 20 displays the screen 1100(d) on the display unit of the user interface 124.

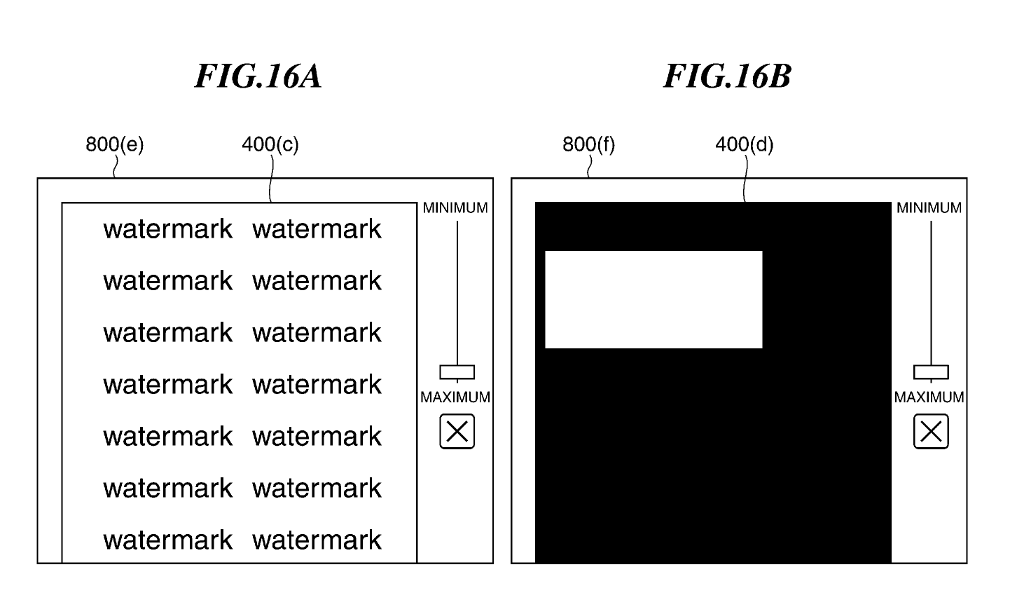

When the enlarging instruction is issued in the state in which the screen 800(c) is displayed, the controller unit 20 displays a screen 800(e) shown in FIG. 16A on the display unit of the user interface 124. The screen 800(e) displays contents corresponding to the record 915 of the preview output definition data 900, and the displayed contents are the same as those shown in FIG. 11A. It should be noted that when the reducing instruction is issued in the state in which the screen 800(e) is displayed, the controller unit 20 displays the screen 800(c) on the display unit of the user interface 124.

When the enlarging instruction is issued (a magnification not less than the maximum magnification is designated) in the state in which the screen 800(e) is displayed, the controller unit 20 displays the screen 800(f) shown in FIG. 16B on the display unit of the user interface 124. The screen 800(f) displays contents corresponding to the record 916 of the preview output definition data 200, and the displayed contents are the same as those shown in FIG. 11B. It should be noted that when the reducing instruction is issued in the state in which the screen 800(f) is displayed, the controller unit 20 displays the screen 800(e) on the display unit of the user interface 124.

As described above, in the present embodiment, a form in which a bound-book image is shown can also be designated as a display form of a preview image, and at a predetermined enlargement ratio, a display form of a preview image can be changed to a form in which a sheet is shown. As a result, when a preview display is small (reduced), the user can see other information while seeing a preview image by a finished bind-book image, and when a preview display is large (enlarged), the user can see the sharpness and tone of characters and watermark prints. Thus, a preview image and information can be displayed in a more suitable form according to an enlargement ratio/reduction ratio of a preview display. Other arrangements and effects are the same as those in the above described first embodiment.

### Other Embodiments

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2009-279441 filed Dec. 9, 2009, which is hereby incorporated by reference herein in its entirety.

What is claimed is:

1. An image display apparatus comprising:
a display unit configured to display a preview image indicative of a printing result of an image to be printed, and information on printing of the image;
a size determination unit configured to determine a size of the preview image displayed by said display unit according to an instruction from a user;
a type determination unit configured to determine a type of information to be displayed on a display part according to the size determined by said size determination unit; and
a display control unit configured to display information of the type determined by said type determination unit in a state in which the preview image is displayed in the display part according to the size determined by said size determination unit.

2. An image display apparatus according to claim 1, further comprising a changing unit configured to change a display form of the preview image to be displayed in the display part according to the size of the preview image determined by said size determination unit.

3. An image display apparatus according to claim 1, further comprising a voice output unit configured to output, by voice, information of a type determined not to be displayed by said type determination unit.

4. An image display apparatus further according to claim 1, wherein the information includes any of the following: a sheet size, a sheet type, a sheet feed cassette, a toner type, an apparatus status, a page number, and the total number of pages.

5. A control method for an image display apparatus, comprising:
a display step of displaying a preview image indicative of a printing result of an image to be printed, and information on printing of the image;
a size determination step of determining a size of the preview image displayed in said display step according to an instruction from a user;
a type determination step of determining a type of information to be displayed on a display part according to the size determined in said size determination step; and
a display control step of displaying information of the type determined in said type determination step in a state in which the preview image is displayed in the display part according to the size determined in said size determination step.

6. A computer-readable non-transitory storage medium storing a program for causing a computer to execute a control method for an image display apparatus according to claim 5.
